(19) United States
(12) Patent Application Publication
(10) Pub. No.: US 2005/0015255 A1
(43) Pub. Date: Jan. 20, 2005

(54) Assistive technology for disabled people and others utilizing a remote service bureau

(75) Inventors: Steven M. Kaye, Weston, CT (US); Matthew L. Phillips, New Milford, CT (US)

Correspondence Address: Pitney Bowes Inc.;Intellectual Property & Technology Law Department, 35 Waterview Drive, P. O. Box 3000, Shelton, CT, 06484, US

(73) Assignee: Pitney Bowes Incorporated, Stamford, CT (US)

(21) Appl. No.: 10/622,332

(22) Filed: Jul. 18, 2003

(51) Int. Cl. G10L 21/06; G10L 21/00

(52) U.S. Cl. 704/271; 704/270; 704/275

(57) ABSTRACT

A method, system, and user apparatus for helping a user, such as a disabled person, to use paper processing equipment like photocopiers and sorting machines. Accordingly, a call for help is received at a remote service bureau; a user profile is checked to find out things like user disabilities; an equipment profile of the user is checked to determine what different types and models of paper processing equipment the user has; and then interactive assistance is provided to the user from the remote service bureau such that the interactive assistance is based at least partly upon the user profile and the equipment profile.

### TECHNICAL FIELD

The present invention relates to paper processing devices and systems, and more particularly to systems for helping disabled people use those devices.

### BACKGROUND OF THE INVENTION

During recent decades, the federal government has encouraged and required both government and private sector employers to enhance accessibility for the disabled. Various inventions have been directed toward this goal, and further progress may be made to meet the federal mandate.

Recent advances have been made in providing disabled access to paper processing products. One approach is to design disabled access to the product. However, this approach has the potential to add cost to the product, and, in fact, may be impractical in the case of original equipment manufacturer (“OEM”) parts or products, which are produced by one company to be marketed under another company's brand.

Another approach to provide disabled access to paper processing products is to add assistive devices to the product. These may range from a Braille label kit to an added personal computer (PC) with a touch screen, voice input, and output that controls the machine and provides an alternative “multi-media” user interface. These assistive technologies approaches have the advantage of not adding cost to the basic product, and instead the assistive devices are marketed as an additional product.

The assistive technologies approach was taken in the Universal Access (UA) photocopier of Eghtesadi et al. (U.S. Pat. No. 6,243,682). Eghtesadi invented a universal access photocopier system that allows handicapped people (i.e., individuals with disabilities) to control and use handicapped people (i.e., individuals with disabilities) to control and use office photocopiers, by coupling an interface to a diagnostic communication port on the photocopier. The user may use voice, a special keyboard, or a touch screen, or any combination of those three means, to operate the photocopier.

Eghtesadi does not involve any live assistance for the disabled user, and, therefore, only users with certain types of disabilities will be able to successfully utilize the invention of Eghtesadi. Moreover, by its nature, the system of Eghtesadi is limited to photocopiers rather than more general paper processing devices and systems.

In the automotive arts, an “OnStar” service is known to provide the latest information and assistance by pressing an OnStar button that connects a user to an OnStar Center where trained, knowledgeable, live advisors are ready to help. For example, see Nixon et al. (U.S. Pat. No. 6,128,482 for “Providing mobile application services with download of speaker independent voice model”) However, this “OnStar” service is not adapted for various disabilities, and has not been applied to paper processing devices and systems.

### SUMMARY OF THE INVENTION

The current invention is a PC-based module capable of providing two-way conferencing with video capability, including remote control capability between the equipment user and a central service bureau. This PC module may be part of a more comprehensive assistive device such as a UA photocopier or UA mailing machine, or it may stand alone. Additionally, the present invention can be retrofitted to specific machines so that hardware devices at the user's location can be controlled locally by the user or remotely through the videoconferencing PC via standard communication protocols such as RS-232 or TCP.IP. Assistive hardware devices could be used to raise and lower a work surface, to adjust a feeder angle, to adjust a separator knob, to adjust a sideguide, et cetera.

According to the method of the present invention, a person obtains live assistance in using a paper processing machine. The assistance is provided by a service bureau that is remote from the person. The service bureau receives a call for help, and checks a user profile of the person. The service bureau also checks an equipment profile of the person. Then the service bureau provides interactive assistance to the person, based at least partly upon the user profile and the equipment profile. The user profile will indicate any disabilities that the user may have, such as visual impairment, tremor in the hands, or cognitive problem. An empty user profile signifies that the person at the user end has no relevant disabilities, but even for such a person, the user profile may contain other types of information such as the level of support purchased by that person from the service bureau. In contrast, the equipment profile will typically indicate what types and models of paper processing equipment the person has available at the user end.

The system of the present invention comprises a user terminal at the person's location, and an operator terminal at the remote service bureau. The operator terminal is responsive to a call for help from the user terminal, the operator terminal having capacity to access the user profile and the equipment profile. The operator terminal also has capacity to provide interactive assistance to the user terminal based at least partly upon the user profile and the equipment profile.

The user terminal of the present invention comprises a communication port for receiving interactive assistance from the remote service bureau. The user terminal also comprises a video camera port for obtaining a video image for transmission from the communication port to the remote service bureau. The interactive assistance is based at least partly upon a user profile of the person, and upon information about the paper processing machine in an equipment profile of the person, and also based upon the video image.

The present invention also encompasses computer software embodied in computer-readable media encoded with a data structure for operating the user terminal of the present invention. This computer software may be available separately in the form of a compact disk, floppy disk, or as a download from the service bureau via the Internet.

### BRIEF DESCRIPTION OF THE DRAWING

FIG. 1 is a flow chart illustrating a preferred embodiment of the method according to the present invention.

FIG. 2 is a block diagram illustrating a preferred embodiment of the system according to the present invention.

FIG. 3 is a block diagram illustrating a user terminal according to the present invention.

### BEST MODE FOR CARRYING OUT THE INVENTION

According to a best mode embodiment of the present invention, when a disabled user needs help with paper processing devices or systems, a button press or a voice command will establish communications with a central service bureau. For example, the central service bureau could be located at, and staffed by, the manufacturer or vendor of the paper processing devices and/or systems.

This link from the user to the central service bureau can be via dial-up, or via broadband connection to the Internet. Specific user profiles are maintained at the central service bureau so that the central service bureau operator is immediately aware of the type of equipment on site, and is also aware of user information such as specific abilities and disabilities. The specific user profiles also ensure that the call for help is routed to an appropriate operator at the central service bureau. The user profile can be sent with the call for help, instead of being maintained at the central service bureau, or both methods could be used.

The following potential scenarios can be realized, among many others, using the present invention. In a first scenario, a blind user attempting to send out a pre-addressed package with a Universal Access Mailing Machine (UAMS) needs to know the destination ZIP code to obtain postage rates, and the central service bureau operator will remotely read the necessary information displayed by the blind user and look up the ZIP code. In a second scenario, a central service bureau operator could read the ZIP code from the package label to the user and could set the meter to the correct postage remotely. In a third scenario, the central service bureau operator could remotely order the meter to produce a tape if desired.

This invention would not be just for blind people. A user with a movement impairment (such as a tremor) would need interactive help reconfiguring a mailing machine to go from printing thin airmail envelopes to printing large items. A trained central service bureau remote operator could help in making thickness and sideguide adjustments for the user.

Also, a user with cognitive impairment might find the rules for sending certified mail difficult to comprehend. A central service bureau operator could explain the rules and, using the video link, insure that the United States Postal Service (USPS) form has been properly filled out. Even a user without any disabilities could benefit from the present invention, because operation of paper processing equipment can sometimes be confusing, especially when complicated forms must be filled out.

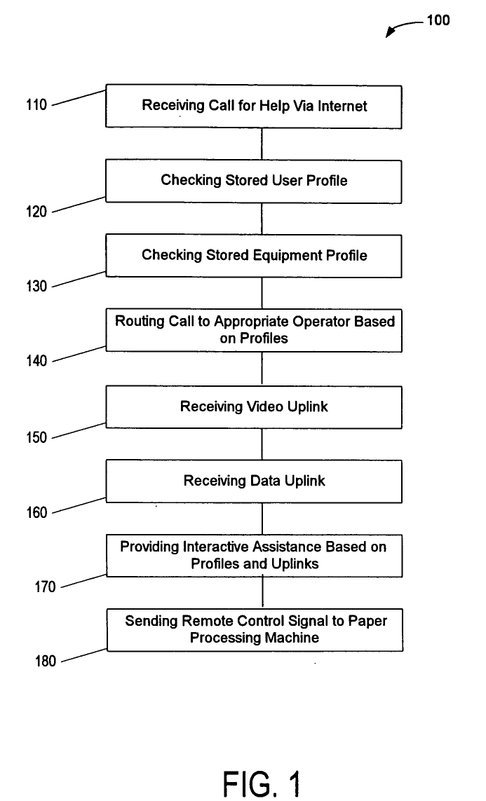

As seen in the method 100 depicted in the flow chart of FIG. 1, a preferred embodiment of the present invention entails the remote service bureau receiving 110 a call for help via the Internet. The service bureau then checks 120 the stored user profile to find out about the users disabilities or lack thereof, and to possibly find out the level of service purchased by the user. The service bureau will also check 130 the stored equipment profile of the person at the user end, to see what types and models of paper processing equipment the person has available, such as photocopiers, paper sorters, mailing machines, et cetera. Based upon these two profiles, the call will be routed 140 to an appropriate operator at the remote service bureau. It should be understood that the service bureau need not be located in a single building, and it is possible that the operators could even be working from their individual homes. The operator of the remote service bureau will receive 150 a video uplink from the user terminal, and also a data uplink 160 that allows the operator to monitor status of the paper processing machine in question, in addition to having a live visual feed from the user's location. The video link will allow the operator to see the machine, or see a document displayed by the person at the user end. Based at least partly upon these two profiles stored at the service bureau, and upon these two uplinks to the service bureau, the service bureau will then provide 170 interactive assistance to the person at the user end. In this preferred embodiment, the service bureau also has the capability to send remote control signal to the paper processing machine, in order to adjust or operate that machine as requested by the person at the user end.

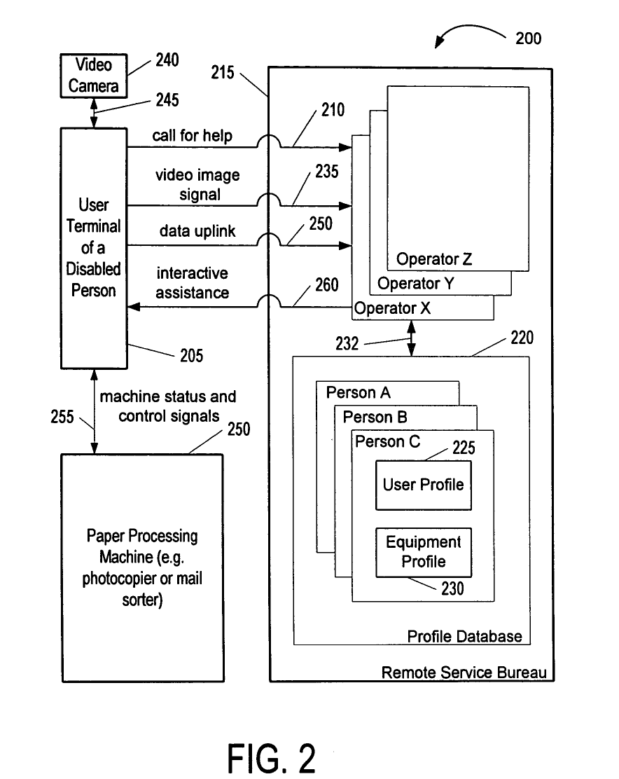

As seen in FIG. 2, a preferred embodiment of the present invention is illustrated in a block diagram of the system 200. The user terminal of a disabled person 205 sends a call for help 210 to a remote service bureau 215. The remote service bureau has a profile database 220 that has profiles for various people (A, B, C, etc.). The profile for each person includes a user profile 225 and an equipment profile 230. Based upon the identity of the disabled person, the service bureau is able to access the appropriate user profile and equipment profile, and thus route the call to an appropriate operator, shown in FIG. 2 as Operator X who is forwarded the relevant information in the database 220, or who has direct access 232 to the database.

The user terminal 205 uploads a video image signal 235 to the operator, the signal having been derived from a video camera 240 that has a connection 245 to the user terminal. Also, the user terminal establishes a data uplink to the operator, having a magnitude indicative of at least one status of a paper processing machine 250 with which the user terminal exchanges signals 255. Based upon the call for help 210, the video image signal 235, the data uplink 250, the user profile 225, and the equipment profile 230, the operator is able to provide interactive assistance 260 to help the disabled person to operate the paper processing machine. This interactive assistance may merely consist of helping the disabled person to prepare to use the machine by filling out a form that is then processed by the machine 250, or it can consist of instructing the disabled person how to use the machine, or the interactive assistance 260 can include a control signal that is passed by the user terminal 205 to the paper processing machine 250 via the signals 255, so that the operator can remotely adjust or operate the machine 250.

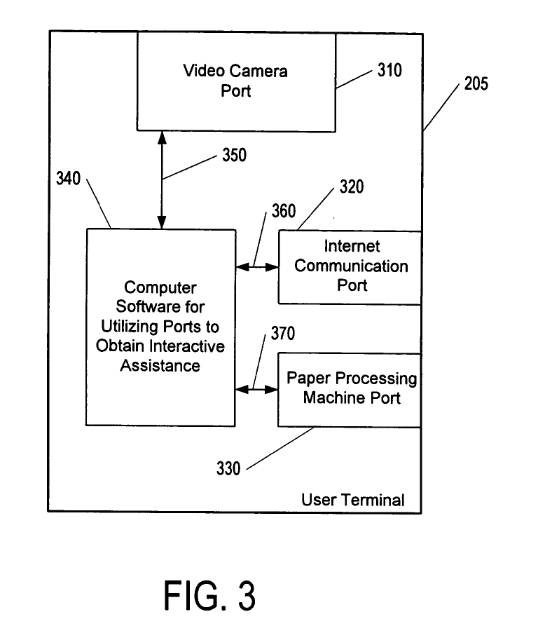

The user terminal 205 is shown in somewhat more detail in FIG. 3. The terminal includes at least one port 310 for connection to a video camera. The user terminal further includes an Internet communication port 320 for communicating with a remote service bureau. The user terminal further includes at least one port 330 for interacting With a paper processing machine. All of these three ports 310, 320, and 330 are connected to computer software 340 via respective connections 350, 360, and 370. The computer software 340 is implemented by a central processing unit or the like, and this software 340 is for utilizing the ports to obtain interactive assistance from a remote service bureau, as has already been described with respect to FIG. 2. The computer software is embodied in computer-readable media encoded with a data structure for operating the user terminal 205.

According to these illustrative embodiments of the present invention, the interactive assistance provided to the disabled person at the user end is customized in response to an indication in the user profile 225 of at least one user disability. For example, if the user profile indicates that the person is deaf, then an operator may be selected who can read sign language. If the user profile indicates that the disabled person is mentally disabled, then the interactive assistance may be provided slowly. Although the user profile 225 and the equipment profile 230 have been shown in FIG. 2 as part of a database within the remote service bureau, it is within the scope of this invention for at least part of these profiles to be automatically uploaded or updated to the service bureau when the call for help 210 is placed. Also, FIG. 2 does not explicitly show a video downlink, but that can certainly be a part of the interactive assistance; if the user terminal has the architecture of a typical personal computer, then a screen will be included, and that screen could accommodate images sent from Operator X to the disabled person.

Various changes may be made in the above illustrative embodiments without departing from the scope of the invention, as will be understood by those skilled in the art. It is intended that all matter contained in the above description or shown in the accompanying drawings shall be interpreted as illustrative and not in a limiting sense. The invention disclosed herein can be implemented by a variety of combinations of hardware and software, and those skilled in the art will understand that those implementations are derivable from the invention as disclosed herein.

1. A method of helping a person to use or prepare to use a paper processing machine, comprising the steps of:
receiving a call for help from the person to a remote service bureau;
checking a user profile of the person;
checking an equipment profile of the person; and
providing interactive assistance from the remote service bureau to the person, in response to the call,
wherein the interactive assistance is based at least partly upon the user profile and the equipment profile.

2. The method of claim 1, wherein the interactive assistance is customized in response to an indication in the user profile of at least one user disability, and wherein the equipment profile comprises information about at least the paper processing machine.

3. The method of claim 1, further comprising the step of receiving a video uplink from the person's location, in order to provide the interactive assistance based partly upon seeing a visual image from the person's location.

4. The method of claim 3, further comprising the step of receiving a data uplink from the person's location, allowing an operator at the remote service bureau to monitor at least one status of the paper processing machine.

5. The method of claim 1, wherein the method includes the step of sending a remote control signal from the remote service bureau to the paper processing machine, for remotely operating or adjusting the paper processing machine.

6. The method of claim 1, wherein the user profile or the equipment profile or both or parts thereof are sent with the call to the remote service bureau.

7. The method of claim 1, wherein the user profile or the equipment profile or both or parts thereof are stored at the remote service bureau between calls for assistance.

8. The method of claim 2, further comprising the step of routing the call to an appropriate operator at the remote service bureau, based at least partly on the indication in the user profile of the at least one user disability.

9. The method of claim 1 wherein all communication between the person's location and the remote service bureau is accomplished via two respective personal computers linked by the Internet.

10. The method of claim 3, further comprising a video downlink signal, for enhancing the interactive assistance provided by the remote service bureau.

11. A system for helping a person use or prepare to use a paper processing machine, comprising:
a user terminal at the person's location;
an operator terminal at a remote service bureau, responsive to a call for help from the user terminal, the operator terminal having capacity to access a user profile and an equipment profile, and the operator terminal also having capacity to provide interactive assistance to the user terminal based at least partly upon the user profile and the equipment profile.

12. The system of claim 11, wherein the interactive assistance is necessarily customized in response to an indication in the user profile of at least one user disability, and wherein the equipment profile comprises information about at least the paper processing machine.

13. The system of claim 11, wherein the user terminal is equipped with a video camera for providing a video image to the operator terminal, and wherein the interactive assistance is based at least partly upon the video image from the person's location.

14. The system of claim 13, wherein the operator terminal is also for receiving a data uplink from the user terminal, allowing an operator at the remote service bureau to monitor at least one status of the paper processing machine.

15. The system of claim 11, wherein the system includes means for sending a remote control signal from the remote service bureau to the paper processing machine, in order to remotely operate or adjust the paper processing machine.

16. The system of claim 11, wherein the call to the remote service bureau includes the user profile or the equipment profile or both or parts thereof.

17. The system of claim 11, further comprising a database at the remote service bureau wherein the user profile or the equipment profile or both or parts thereof are stored.

18. The system of claim 12, wherein the operator terminal is selected based at least partly on the indication in the user profile of the at least one user disability.

19. The system of claim 11 wherein the user terminal and the operator terminal are personal computers linked by the Internet.

20. The system of claim 13, wherein the operator terminal is further for providing a video downlink signal, for enhancing the interactive assistance provided to the user terminal.

21. A user terminal for helping a person use or prepare to us a paper processing machine, comprising:
a communication port for receiving interactive assistance from a remote service bureau; and
a video camera port for receiving a video image from a video camera at the person's location,
wherein the interactive assistance is based at least partly upon a user profile of the person, upon information about the paper processing machine in an equipment profile of the person, and upon the video image.

22. The user terminal of claim 21, wherein the user terminal further comprises at least one machine port for operatively connecting the user terminal to the paper processing machine, and wherein the interactive assistance comprises remote control signals that remotely operate or adjust the paper processing machine.

23. The user terminal of claim 21, wherein the interactive assistance is customized in response to an indication in the user profile of at least one disability of the person.

24. Computer software embodied in computer-readable media encoded with a data structure for operating a user terminal in such a manner as to help a person use or prepare to use a paper processing machine, wherein the data comprises:
code to operate a communication port of the user terminal, for receiving interactive assistance from a remote service bureau; and
code to operate a video camera port of the user terminal, for receiving a video image from a video camera at the person's location,
wherein the interactive assistance is based at least partly upon a user profile of the person, upon information about the paper processing machine in an equipment profile of the person, and upon the video image.

25. The computer software of claim 24, further comprising code to operate at least one machine port of the user terminal, for operatively connecting the user terminal to the paper processing machine, and wherein the interactive assistance comprises remote control signals that remotely operate or adjust the paper processing machine.

26. The computer software of claim 24, wherein the interactive assistance is customized in response to an indication in the user profile of at least one disability of the person.
